(19) United States
(12) Patent Application Publication
(10) Pub. No.: US 2016/0110593 A1
(43) Pub. Date: Apr. 21, 2016

(54) IMAGE BASED GROUND WEIGHT DISTRIBUTION DETERMINATION

(71) Applicant: Microsoft Corporation, Redmond, WA (US)

(72) Inventors: Jonathan Hoof, Kenmore, WA (US); Daniel Kennett, Bellevue, WA (US)

(21) Appl. No.: 14/517,042

(22) Filed: Oct. 17, 2014

(51) Int. Cl. G06K 9/00; G06F 3/01; G06T 7/60

(52) U.S. Cl. CPC G06K 9/00342; G06T 7/602; G06K 9/00362; G06F 3/017; G06T 2207/30196; G06T 2207/10028

(57) ABSTRACT

A sequence of images is processed to interpret movements of a user. The user's contour and center of gravity are determined and tracked. Based on points of contact between the user and the environment, and upon tracked movement of the center of gravity, forces impressed by the user upon the points of contact with the environment may be deduced by constraint analysis. This center-of-mass model of user movements may be used in conjunction with a skeletal model of the user to provide verification of the validity of the skeletal model. The center-of-mass model may also be used alternatively with the skeletal model fails during those times when use of the skeletal model is problematic.

### BACKGROUND

Many computing applications such as computer games, multimedia applications, or the like use controls to allow users to manipulate game characters or other aspects of an application. Conventionally, such controls are input using, for example, controllers, remotes, keyboards, mice, or the like. Unfortunately, such controls may be difficult to learn, thus creating a barrier between a user and such games and applications. Furthermore, such controls may be different than actual game actions or other application actions for which the controls are used. For example, a game control that causes a game character to swing a baseball bat may not correspond to an actual motion of swinging the baseball bat.

Recently, cameras have been used to allow users to manipulate game characters or other aspects of an application without the need for conventional handheld game controllers. More specifically, computing systems have been adapted to identify users captured by cameras, and to detect motion or other behaviors of the users, i.e., providing virtual ports to the system.

### SUMMARY

A sequence of images may be processed to interpret movements in a target recognition, analysis, and tracking system. The system may determine the contour of a targeted user from an image or sequence of images, and determine points of contact between the user and the environment, e.g., the points where a user is touching the floor or other fixtures or objects. From the contour, the center of mass of the user may be estimated, and various aspects, such as acceleration, motion, and/or balance of the center of mass may be tracked. This method may be implemented in a variety of computing environments as a series of computations using an image or sequence of images, whereby the contour of the targeted user, points of contact, center of mass, and balance, acceleration, and/or movement of the center of mass are computed. Further, the methods may be encapsulated on machine-readable media as a set of instructions which may be stored in memory of a computer/computing environment and, when executed, enable the computer/computing environment to effectuate the method.

From the motion of the center of mass and from knowledge of the points of contact, the forces acting on the center of mass may be inferred, without regard to any knowledge of the user's skeletal structure or relative position of limbs, for instance. This may aid in the construction of an accurate avatar representation of the user and the user's actions on a display and accurate kinetic analysis. The accuracy further may be enhanced by foreknowledge of the users intended movements and/or an additional skeletal tracking of the user.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an example perspective drawing of a user playing a gesture-based game using a gaming console, television, and image capture device.

FIG. 2 is an example system diagram of a user holding an object in an environment with multiple fixtures, along with a computing system, a display, and an image capture device.

FIG. 3 illustrates an example system block diagram of a gaming console computing environment.

FIG. 4 is an example system block diagram of a personal computer.

FIG. 5 is an example system block diagram of a handheld wireless device such as a cellular telephone handset.

FIG. 6 is an example two-dimensional representation of information derived from a sequence of images of a user.

### DETAILED DESCRIPTION

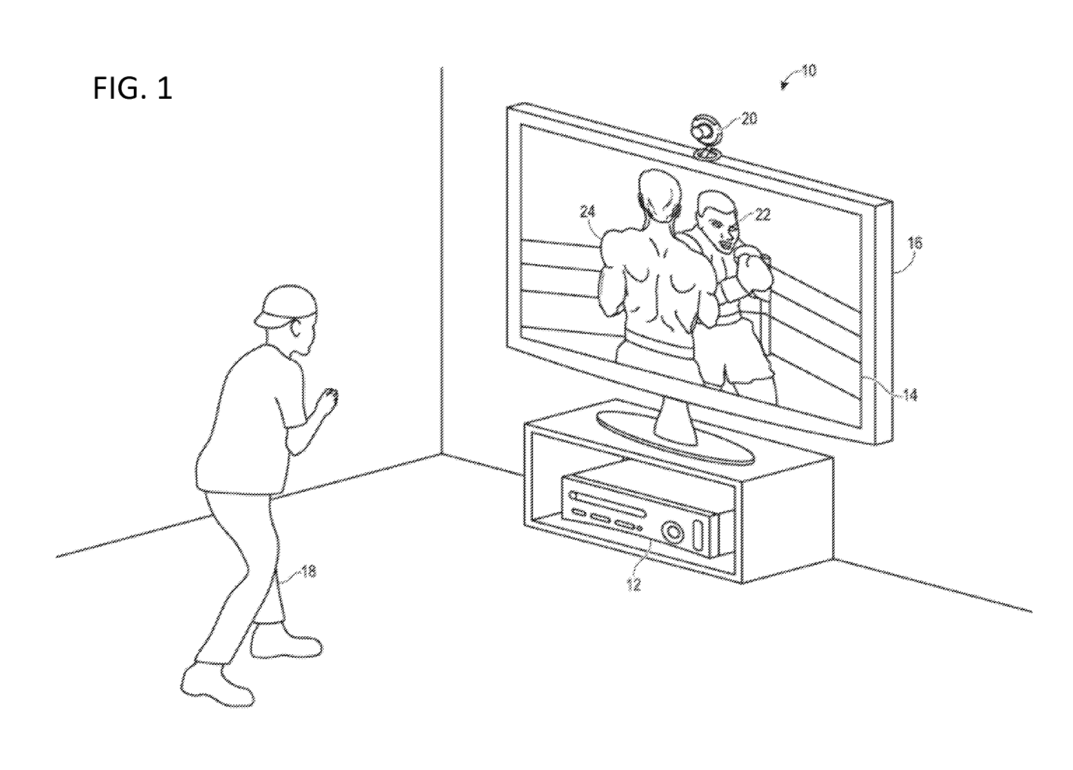

FIG. 1 shows an example of a motion sensing and analysis system in the case of a user playing a gesture-based game using a gaming console, television, and image capture device. System 10 may be used to bind, recognize, analyze, track, associate to a human target, provide feedback, and/or adapt to aspects of the human target such as the user 18.

As shown in FIG. 1, the system 10 may include a computing environment 12. The computing environment 12 may be a computer, a gaming system or console, smart phone, or the like. System 10 may further include a capture device 20. The capture device 20 may be, for example, a detector that may be used to monitor one or more users, such as the user 18, such that gestures performed by the one or more users may be captured, analyzed, and tracked to perform one or more controls or actions within an application, as will be described in more detail below. Capture device 20 may be of any conventional form. It may be a single lens digital camera capturing two-dimensional optical images in the visual, infrared (IR), ultraviolet, or other spectrum. It may be a dual-lens stereoscopic device, for instance. It may be a radar, sonar, infrared, or other scanning device capable of generating depth maps of the observed scene. The capture device 20 may also be a composite device providing a mixture of color, brightness, thermal, depth, and other information in one or more image outputs, and may comprise multiple scanning and/or camera elements.

System 10 may include an audiovisual device 16 such as a television, a monitor, a high-definition television (HDTV), or the like that may provide feedback about virtual ports and binding, game or application visuals and/or audio to the user 18. For example, the computing environment 12 may include a video adapter such as a graphics card and/or an audio adapter such as a sound card that may provide audiovisual signals associated with the feedback about virtual ports and binding, game application, non-game application, or the like. The audiovisual device 16 may receive the audiovisual signals from the computing environment 12 and may then output the game or application visuals and/or audio associated with the audiovisual signals to the user 18. Audiovisual device 16 may be connected to the computing environment 12 via, for example, an S-Video cable, a coaxial cable, an HDMI cable, a DVI cable, a VGA cable, a wireless connection or the like.

System 10 may be used to recognize, analyze, and/or track a human target such as the user 18. For example, the user 18 may be tracked using the capture device 20 such that the position, movements and size of user 18 may be interpreted as controls that may be used to affect the application being executed by computer environment 12. Thus, the user 18 may move his or her body to control the application.

When no user is in the capture area of the capture device 20, system 10 may provide feedback about this unbound/non-detection state of system 10. When the user 18 enters into the capture area of the capture device 20, the feedback state may change from a state of unbound/non-detection to a feedback state of unbound/detecting. System 10 may then bind to the user 18, which may change the feedback state from unbound/detecting to bound. After the user 18 is bound to a computing environment 12, he may make a gesture which will turn the rest of system 10 on. The user 18 may also make a second gesture which will enter him into association with a virtual port. The feedback state may change such that a user 18 knows he is associated with the virtual port. The user 18 may then provide a series of gestures to control system 10. For example, if the user 18 seeks to open one or more menus, or seeks to pause one or more processes of system 10, he may make a pause or menu gesture. After finishing with the computing session, the user may make an exit gesture, which may cause system 10 to disassociate the user 18 with the virtual port. This may cause the feedback state to change from the state of associated with a virtual port to the state of bound/detected. The user 18 may then move out of the range of the sensors, which may cause the feedback state to change from bound/detected to non-detection. If a system 10 unbinds from the user 18, the feedback state may change to an unbound state.

The application executing on the computing environment 12 may be, as depicted in FIG. 1, a boxing game that the user 18 may be playing. For example, the computing environment 12 may use the audiovisual device 16 to provide a visual representation of a boxing opponent 22 to the user 18. The computing environment 12 may also use the audiovisual device 16 to provide a visual representation of a user avatar 24 that the user 18 may control with his or her movements on a screen 14. For example, the user 18 may throw a punch in physical space to cause the user avatar 24 to throw a punch in game space. Thus, the computer environment 12 and the capture device 20 of system 10 may be used to recognize and analyze the punch of the user 18 in physical space such that the punch may be interpreted as a game control of the user avatar 24 in game space.

The computing environment 12 would normally include a conventional general-purpose digital processor of the von Neumann architecture executing software or firmware instructions, or equivalent devices implemented via digital field-programmable gate-array (FPGA) logic devices, application-specific integrated circuit (ASIC) devices, or any equivalent device or combinations thereof. Processing may be done locally, or alternatively some or all of the image processing and avatar generation work may be done at a remote location, not depicted. Hence the system shown could, to name but a few configurations, be implemented using: the camera, processor, memory, and display of a single smart cell phone; a specialty sensor and console of a gaming system connected to a television; or using an image sensor, computing facility, and display, each located at a separate facility. Computing environment 12 may include hardware components and/or software components such that the may be used to execute applications such as gaming applications, non-gaming applications, or the like.

The memory may comprise a storage medium having a concrete, tangible, physical structure. As is known, a signal does not have a concrete, tangible, physical structure. Memory, as well as any computer-readable storage medium described herein, is not to be construed as a signal. The memory, as well as any computer-readable storage medium described herein, is not to be construed as a transient signal. The memory, as well as any computer-readable storage medium described herein, is not to be construed as a propagating signal. The memory, as well as any computer-readable storage medium described herein, is to be construed as an article of manufacture.

The user 18 may be associated with a virtual port in computing environment 12. Feedback of the state of the virtual port may be given to the user 18 in the form of a sound or display on audiovisual device 16, a display such as an LED or light bulb, or a speaker on the computing environment 12, or any other means of providing feedback to the user. The feedback may be used to inform the user 18 when he is in a capture area of the capture device 20, if he is bound to system 10, what virtual port he is associated with, and when he has control over an avatar such as avatar 24. Gestures by user 18 may change the state of system 10, and thus the feedback that the user 18 receives from system 10.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the user avatar 24. For example, the user 18 may use movements to enter, exit, turn system on or off, pause, volunteer, switch virtual ports, save a game, select a level, profile or menu, view high scores, communicate with a friend, etc. Additionally, a full range of motion of the user 18 may be available, used, and analyzed in any suitable manner to interact with an application.

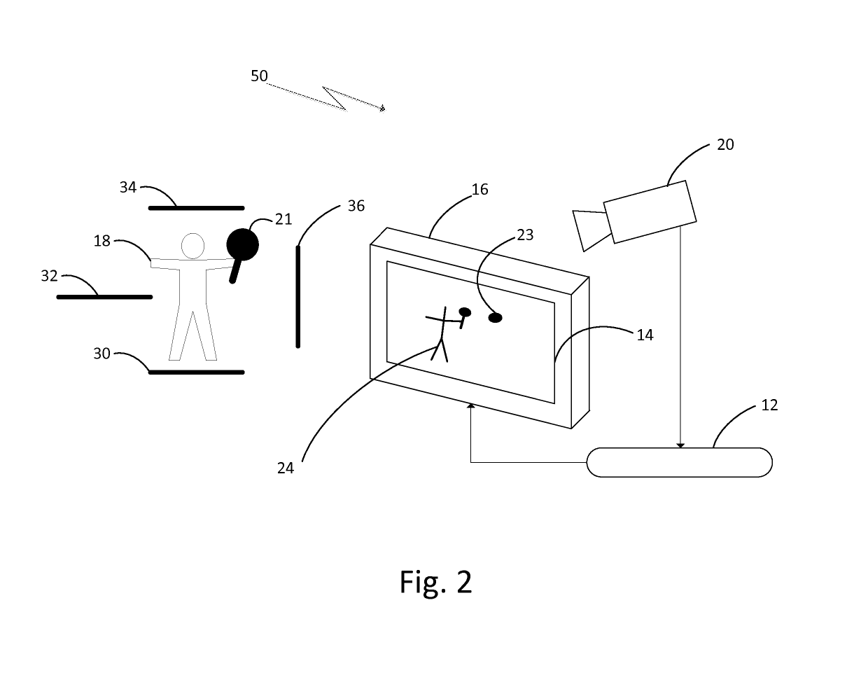

FIG. 2 is a system diagram of a system 50, which is similar to system 10 of FIG. 1. Here in FIG. 2, user 18 is holding an object 21 (e.g., a tennis racket) in an environment with multiple fixtures. System 50 includes audiovisual device 16 with screen 14 on which the avatar 24 of user 18 is depicted. Avatar 24 is created by computing environment 12 via analysis of a sequence of images provided by capture device 20.

User 18 may move his center of mass by impressing force upon any of the fixtures, e.g., by shifting weight from foot to foot on floor 30. A fixture may be any relatively stable object capable of bearing a significant portion of the user's weight. As depicted here, the fixtures might include permanent fixtures such as a floor 30, a ballet limber bar 32, a chin-up bar handle 34, and a wall or door frame 36. A fixture could also be a moveable fixture such as a chair or table, or even a box. A fixture may also be a piece of exercise gear, such as step platform, a bench, or even an exercise ball, for example. Further still, a fixture could be an object moved or operated by the user in the course of the user's locomotion, such as a cane, crutch, walker, or wheelchair, for example.

In FIG. 2, screen 14 shows a ball 23 which does not exist in the physical environmental of user 18. Via capture device 20, computing environment 12 may track the motions both of the user 18 and the object 21 he wields, to allow user 18 to control what happens in the virtual world depicted on screen 14. User 18 may interact with the image onscreen by making motion which changes the relative position of his avatar 24 and ball 23.

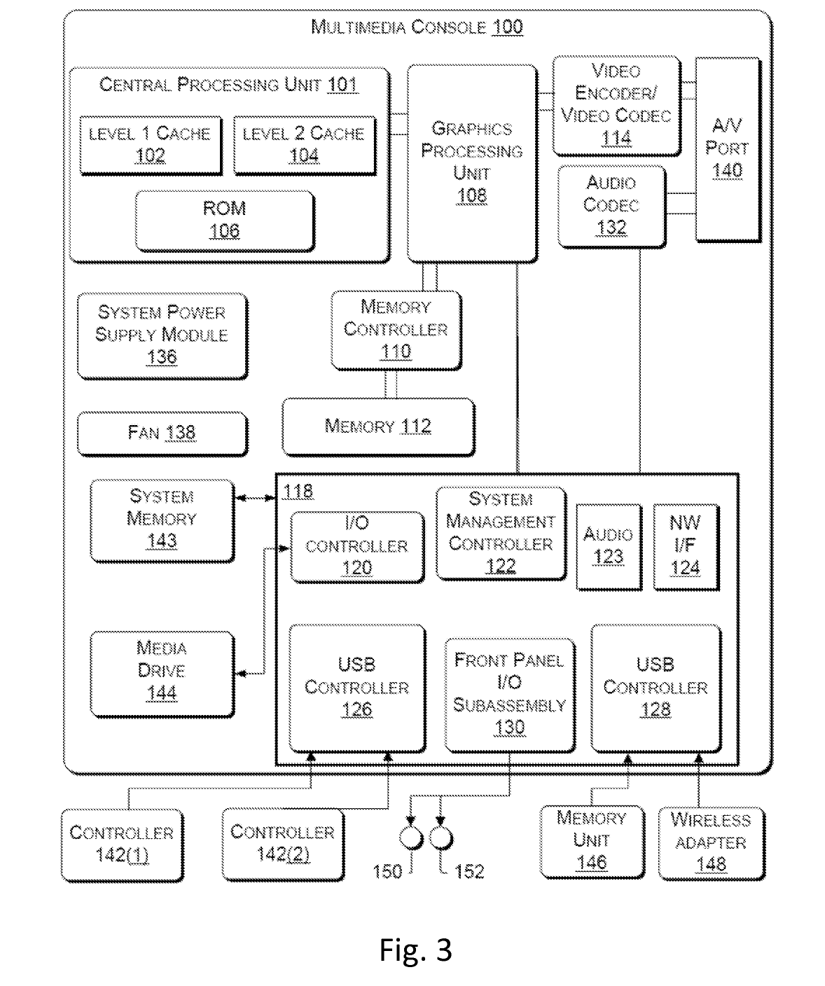

FIG. 3 illustrates a multimedia console 100 that may be used as the computing environment 12 described above with respect to FIGS. 1 and 2 to. e.g., interpret movements in a target recognition, analysis, and tracking system. As shown in FIG. 3, the multimedia console 100 has a central processing unit (CPU) 101 including a processor core having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The front panel I/O subassembly 130 may include LEDs, a visual display screen, light bulbs, a speaker or any other means that may provide audio or visual feedback of the state of control of the multimedia control 100 to a user 18. For example, if the system is in a state where no users are detected by capture device 20, such a state may be reflected on front panel I/O subassembly 130. If the state of the system changes, for example, a user becomes bound to the system, the feedback state may be updated on the front panel I/O subassembly to reflect the change in states.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures may include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 Kbs), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., popups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. Capture device 20 may define additional input device for the console 100.

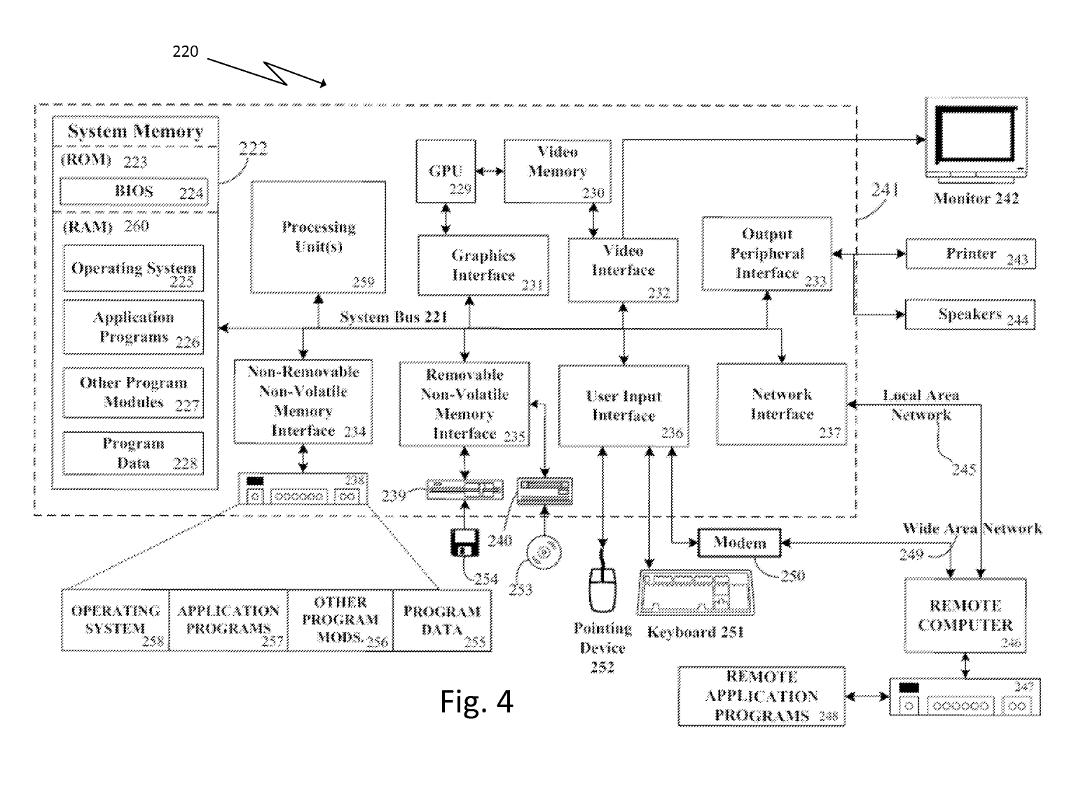

FIG. 4 illustrates an example of a computing environment 220 that may be used as the computing environment 12 shown in FIGS. 1 and 2 to, e.g., interpret movement in a target recognition, analysis, and tracking system. The computing environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary computing environment 220. The various depicted computing elements may include circuitry configured to instantiate specific aspects of the present disclosure. For example, the term circuitry used in the disclosure may include specialized hardware components configured to perform function(s) by firmware or switches. In other examples the term circuitry may include a general purpose processing unit, memory, etc., configured by software instructions that embody logic operable to perform function(s). In examples where circuitry includes a combination of hardware and software, an implementer may write source code embodying logic and the source code may be compiled into machine readable code that may be processed by the general purpose processing unit. Since one skilled in the art may appreciate that the state of the art has evolved to a point where there is little difference between hardware, software, or a combination of hardware/software, the selection of hardware versus software to effectuate specific functions is a design choice left to an implementer. More specifically, one of skill in the art may appreciate that a software process may be transformed into an equivalent hardware structure, and a hardware structure may itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media may be any available media that may be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that may be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through a non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components may either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, which may take the form of a mouse, trackball, or touch pad, for instance. Other input devices (not shown) may include a microphone, joystick, game pad, satellite dish, scanner, or the like. These and other input devices are often connected to the processing unit 259 through a user input interface 236 that is coupled to the system bus 221, but may be connected by other interface and bus structures, such as a parallel port, game port or a universal serial bus (USB). The cameras 27, 28 and capture device 20 may define additional input devices for the console 100. A monitor 242 or other type of display device is also connected to the system bus 221 via an interface, such as a video interface 232, which may operate in conjunction with a graphics interface 231, a graphics processing unit (GPU) 229, and/or a video memory 229. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 4 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

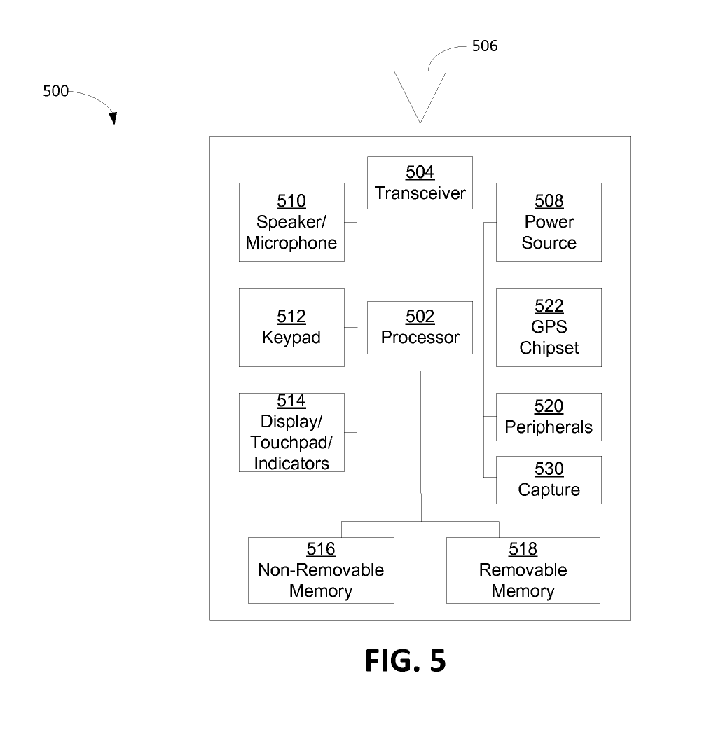

FIG. 5 illustrates an example of a computing device 500 that may be used as the computing environment 12 shown in FIGS. 1 and 2 to, e.g., interpret movement in a target recognition, analysis, and tracking system. Computing environment 500 may be, for instance, a mobile station, a fixed or mobile subscriber unit, a pager, a cellular telephone, a personal digital assistant (PDA), a smartphone, a laptop, a netbook, a tablet, a personal computer, a wireless sensor, consumer electronics, or the like. As shown in FIG. 5, the device 500 may include a processor 502, a transceiver 504, a transmit/receive element 506, a speaker/microphone 510, a keypad 512, a display/touchpad 514, non-removable memory 516, removable memory 518, a power transceiver 508, a global positioning system (GPS) chipset 522, an image capture device 530, and other peripherals 520. It will be appreciated that device 500 may include any sub-combination of the foregoing elements.

Processor 502 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 502 may perform signal coding, data processing, power control, input/output processing, and/or any other functionality that enables device 500 to operate in a wireless environment. The processor 502 may be coupled to the transceiver 504, which may be coupled to the transmit/receive element 506. While FIG. 5 depicts processor 502 and the transceiver 504 as separate components, it will be appreciated that processor 502 and the transceiver 504 may be integrated together in an electronic package or chip. Processor 502 may perform image and movement analysis, or it may cooperate with remote devices via wireless communications to accomplish such analyses, for example.

The transmit/receive element 506 may be configured to transmit signals to, or receive signals from, e.g., a WLAN AN. For example, the transmit/receive element 506 may be an antenna configured to transmit and/or receive RF signals. The transmit/receive element 506 may support various networks and air interfaces, such as WLAN (wireless local area network), WPAN (wireless personal area network), cellular, and the like. The transmit/receive element 506 may be an emitter/detector configured to transmit and/or receive IR, UV, or visible light signals, for example. The transmit/receive element 506 may be configured to transmit and receive both RF and light signals. It will be appreciated that the transmit/receive element 506 may be configured to transmit and/or receive any combination of wireless or wired signals.

Processor 502 may access information from, and store data in, any type of suitable memory, such as non-removable memory 516 and/or removable memory 518. Non-removable memory 516 may include random-access memory (RAM), read-only memory (ROM), a hard disk, or any other type of memory storage device. Removable memory 518 may include a subscriber identity module (SIM) card, a memory stick, a secure digital (SD) memory card, and the like. The processor 502 may access information from, and store data in, memory that is not physically located on device 500, such as on a server or a home computer. The processor 502 may be configured to control lighting patterns, images, or colors on the display or indicators 42 in response to various user requests, network conditions, quality of service policies, etc.

The processor 502 may receive power from the power transceiver 508, and may be configured to distribute and/or control the power to the other components in device 500. The power transceiver 508 may be any suitable device for powering device 500. For example, the power transceiver 508 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 502 may also be coupled to the GPS chipset 522, which is configured to provide location information (e.g., longitude and latitude) regarding the current location of device 500.

The processor 502 may also be coupled to the image capture device 530. Capture device may be a visible spectrum camera, and IR sensor, a depth image sensor, etc.

The processor 502 may further be coupled to other peripherals 520, which may include one or more software and/or hardware modules that provide additional features, functionality and/or wired or wireless connectivity. For example, the peripherals 520 may include an accelerometer, an e-compass, a satellite transceiver, a sensor, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

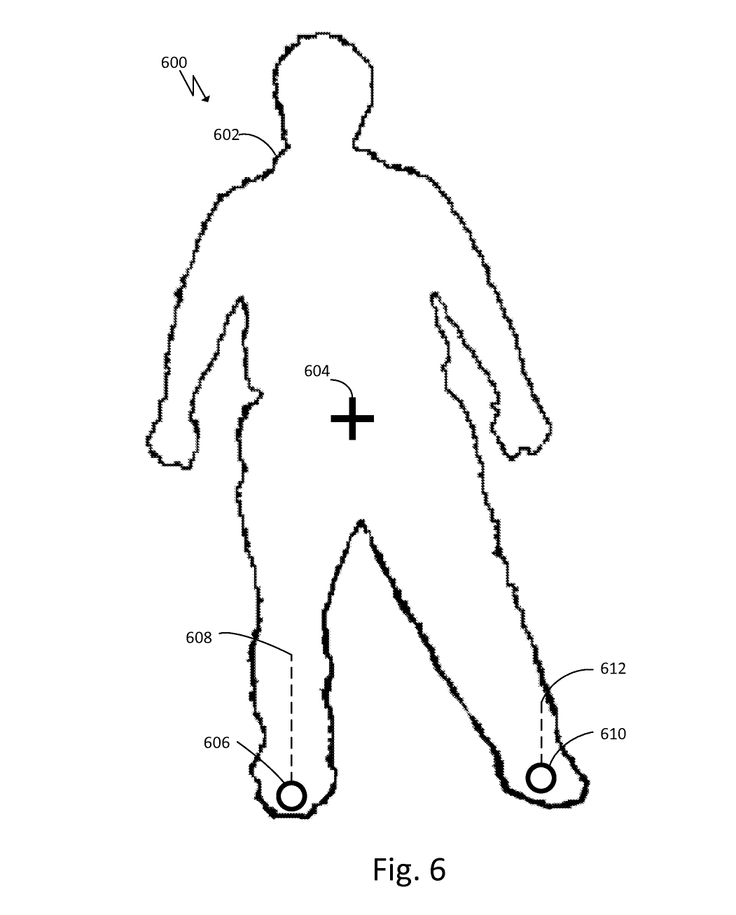

FIG. 6 is a depiction in two dimensions 600 of information computed from one or more imaged captured of a user in his physical environment. Here in FIG. 6, from the image, the processor has determined a contour 602 of a user, here shown as an outline. Here the user is standing. The processor has estimated the location of the center of mass of the user 604, shown here marked with a cross. The processor has determined two points of contact between the user and a fixture. In this case the fixture is the floor. Assuming the user is facing the image capture device, contact point 606 is the user's right foot, and contact point 610 is his left foot. The system has also computed the ground weight impressed upon the fixture by each point of contact, as shown in dashed lines with lengths proportional to the weight impressed, lines 608 and 612. Note that weight on the right foot 608 is greater than the weight on the left foot 612.

Contour 602 may serve as the avatar 24 of FIGS. 1 and 2, or it may serve as the basis for generating such an avatar. Thus the user may see an image or representation of himself including consisting of, or comprising, an outline. Alternatively an avatar may be, for example, a photographic or digitally-generated graphic image corresponding roughly to the outline user 18 presents to the system. Over this representation of the user, information about his balance and movement may be overlaid. In FIG. 6, the static force impressed by each foot is shown as the vertical dashed lines 208 and 212. Alternatively, the weight could be shown, for instance, as discs radiating out from the point of contact along the plane of the floor, and these discs could vary in size, color, or both, dynamically in proportion to the weight impressed. Center of gravity 604 could be depicted by a cross which varies in position as the user's balance shifts, and varies in color in proportion to its acceleration.

The instantaneous weight borne by each point of contact may be computed directly from: the locations of the points of contact between the user and the fixtures; the mass of the user; and the location and acceleration of the center of mass of the user. The outline of the user, including user height and width, may be estimated by a computing system from image data due to the user's motion, color, temperature, and range from the image sensor. A model of the environment, including fixtures, is similarly inferable from image data due to its lack of motion, color, temperature, and/or range from sensor, and/or alternatively be deemed to include any objects determined not to be the user.

Total mass of the user may be estimated, for instance, by assuming an average density of the user and/or by reference to lookup tables of average masses according to observed height and width of users, etc. Notably this is achievable with merely 2D (two dimensional) imaging, although 3D (three dimensional)/depth imaging may provide more accurate assessments of user total volume and hence mass. For example, from a depth image taken from the front of a user, a “depth hull” model of the front of the user may be determined, and from this a 3D depth hull of the entire user may be inferred. Significantly, the true mass of the user may not be necessary to compute, for instance, relative weight distribution among points of contact. Once a user's total mass is estimated, the location of the center of a user's mass may be computed as the centroid of the mass component elements.

Points of contact with fixtures are inferable from location of objects in the environment relative to those points on a user which are most distant from the user's center of gravity. Identification of anatomical extremities may not be needed per se. For instance, in the case that the only fixture is a floor, it is inferable that the only points of contact will be where the user image intersects with, or is tangent upon, the floor. These will be the user's feet if he is standing, knees if kneeling, or hands if doing a hand-stand, etc. Which specific part of the user's body is touching the fixture is not pertinent to the weight and weight distribution computations per se. It suffices to know how many points of contact there are, and where they are in relation to the center of mass.

Acceleration of a user's center of mass may be computed from the change in position of the center of mass over time. Here, the computing system need only compare the center of mass position from a time sequence of images and measure how quickly the center of mass moved, in which direction, and at what speed, to then deduce acceleration.

Once the points of contact, center of mass, and acceleration of center of mass are known, the net forces impinging upon the center of mass, and upon the fixtures at the points of contact, are calculable by the arithmetic of Newtonian kinetics. There are a number of methodologies available for performing such calculations. Rigid body physics, for example, has been applied to video games, medical motion analysis and simulation, and forward and inverse robot kinematics. For present purposes, a computing system may automatically solve for forces impinging upon a point of contact as a rigid body as constraint satisfaction problem where the values of directions of forces and torques are found via iterative computation, as is done in iterative dynamics with temporal coherence.

The position and motion of the center of mass, and the geometry of the center of mass relative to contact points, determine the state vector at each contact point. For example, the position and motion of these points determine the magnitude direction of the velocity of the points and of the torques acting upon them. Factoring in gravity, the inertia tensor of the user at each point of contact may be inferred. The forces responsible for changes in movement or tension can be computed by comparing what is happening from one frame of time to the next.

Exemplary Formula 1, below, may be used in such an analysis. In Formula 1, M is a matrix of masses. V¹ and V² are vectors containing the linear and angular velocities at a time 1 and a time 2. Δt is the change in time from time 1 to time 2. J is a Jacobian matrix of partial differentials describing the constrained forces acting on the masses. J^{T} is the transpose of the Jacobian matrix J. As used here, λ (lambda) is a vector of undetermined multipliers of the magnitude of the constraint forces. J^{T}λ is the transpose of the Jacobian times lambda, which yields the forces and torques acting on the masses. Fext is a vector of the forces and torques external to the system of masses, such as gravity. In Formula 1, the vector of mass times the vector of differential velocities is equal to the change in time multiplied by the sum of the vectors of internal and external forces and torques acting on the masses.

M(V²−V¹)=Δt(J^{T}λ+Fₑₓₜ) Formula 1.

Where the geometry and actual motion of the masses has been observed, the computing system may effectuate solving Formula 1 by filling in the other variables and solving for λ. The direction of each the constraint controls how J^{T} is initially computed, so the direction and value of a particular force may then be computed by multiplying the corresponding J^{T} and λ matrix elements.

In practice, a computational system may thus effectuate the computation of the state vector of a contact point at a series of frames of time based on the center of mass's state vector and the vector to the contact point. Then the stated vectors may be compared from frame to frame, and the magnitude and vectors of operative forces computed in accordance with what would be consistent for all contact points. This computation may be done by adjusting the state vectors in each iteration, as the system iterates over the contact points over and over again, e.g., in a Gauss-Seidel fashion. Gravity is factored in by assuming that in the intervening time between frames, the user will naturally start to fall. Therefore, among the forces computed are the forces necessary to “stop” this falling. Once the solutions converge, the final forces at the contact points may be reported the user, e.g., as symbolic displays of force magnitude and direction, or used to determine user compliance with a specified regiment of motion, such as a particular exercise.

Notably this method produces reliable estimates of static and dynamic ground weight distribution regardless of the pose, posture, or movement of the user. Therefore it is useful in situations where systems relying upon modeling of the user skeleton or musculature may produce less robust results. The latter may occur in poses or postures of the body are obscured to the imaging sensor during some or all of a particular exercise or dance routine, for instance.

The accurate generation of an avatar and weight distribution feedback to the user may be achieved in part by foreknowledge of the intended sequence of motions of a user and skeletal modeling when available. For example, to track a user during a squat exercise, skeletal modeling may be employed when the exercise begins with the user standing fully upright. As the user dips low enough that the imaging sensor's line of sight to the user's pelvis and abdomen are occluded by the user's knees, precise positioning of body segments may be difficult to determine. However, the user's balance from foot to foot may still be assessed, without reference to the skeletal model, by observing accelerations on the user's overall center of mass relative to contact points with the floor. As the user returns to the standing position, the system may return to full skeletal modeling. Similar mixtures of skeletal modeling and overall center of mass acceleration modeling may be tailored to any number of, for instance, dances, yoga poses, stretches and strength exercises, or rehabilitative protocols.

Similarly, foreknowledge of fixtures may be factored in to creating accurate models. If chin-ups are called for, for instance, the system may seek to identify fixtures above the user's head. If the use of a cane in the right hand is stipulated, a three-legged user silhouette may be mapped to an appropriately accommodated avatar, and the amount of force impressed upon the cane at various points in the user's stride may be assessed.

These techniques can apply to the analysis of a single image. The computing platform may be a processor, a memory coupled to the processor containing instructions executable by the processor, and a memory coupled to the processor containing a sequence of images from an image capture device, where the processor by executing the instructions effectuates the determination of a first force comprising a relative magnitude and a direction, where the a force is impressed upon a fixture at a point of contact by a targeted user. In other words, the stance of a person—or of an animal, or even of a walking robot—within the range of the image capture device may be analyzed from a single image. There may be many people in the field of view of the image capture device. The system would first have to determine which of these users would be targeted for analysis.

The analysis may begin with computing of a contour of the targeted user from a first image. Then, from the contour, a center of mass may be computed. The center of mass may depend on expected depths and density of the contour, based on a 2D image, or in part based on the observed depth of the contour in the case of 3D/depth image. Next, the system may determine a point of contact where the user touches a fixture. From just these variables, the relative or actual magnitude and direction of the force can be computed. This could be done be Newtonian arithmetic, or by number-fitting methods such as constraint analysis. In either case, the force can be determined from the observed geometrical relationship of the center of mass to the first point of contact. Similarly, the static forces on each of multiple points of contact can be found from a single image by these methods.

From two or more images, information about dynamic forces and acceleration may be obtained. After the analysis of the first image, a second contour is computed from a second image. Movement of the center of mass of the user can be computed by comparing either the first and second contour or first and second centers of mass computed from those contours. The rate of acceleration of the center of mass of the user can then be computed based on how far apart in time the two images were captured. This can be found by comparing the timestamps of the images, which is either explicit in the metadata of the images or implicit in knowledge of the frame rate of the capture device. Once again, the forces that caused the movement and acceleration, or the net or equivalent forces necessary to achieve such movement and acceleration, can be found via constraint analysis, this time using not only the geometrical relationship of the center of mass to the to the first point of contact, but also the movement and/or acceleration data.

Target recognition, analysis, and tracking systems have often relied on skeletal tracking techniques to detect motion or other user behaviors and thereby control avatars representing the users on visual displays. The methods of computing forces on the center of mass of a user can be combined with skeletal tracking techniques to provide seamless tracking of the user even where skeletal tracking techniques by themselves may not be successful in following the user's behavior. Where the computing system effectuates the modeling of an avatar of the targeted user for visual display, it may, during a first period, effectuate modeling of the avatar by mapping plural identifiable portions of the contour of the user to skeletal segments of the avatar. In other words, when the system can identify the arms, legs, head, and torso specifically, an accurate avatar can be created by mapping the observed body portions to the corresponding portions of the avatar.

Then at a later time, during a second period, the modeling of the avatar can be effectuated by inferring the movement of the skeletal segments of the avatar in accordance with the movement of the center of mass. In other words, when for whatever reason the system cannot tell where the limbs are, it may still be able to tell where the center of the mass of the user is, and cause the motion of the avatar to move according to changes in the user's center of mass. Then at a third time the system could switch back to using skeletal modeling in generating the avatar.

Any number of methods may be used to determine which modeling method will be used at which time to create the avatar. The decision may be based, for example, on confidence levels of joint tracking data of a skeletal model, on the context in which the user is observed, or a combination of the two. For example, if the skeletal model suggests that parts of the body are situated in an implausible or anatomically impossible posture, the computing system can effectuate processing of the avatar via the center-of-mass model. For instance, if the skeletal system has the feet clearly not under the user's center-of-mass, and the center-of-mass is not moving, then we have an invalid situation, and the center-of-mass model will be preferred over the skeletal model.

The level of confidence at used to trigger a change in the modeling method used can depend upon what motions are expected by the user. For instance, certain yoga poses may be more likely to invert limb positions than more ordinary calisthenics. Hence different thresholds of confidence may apply in different situations.

Similarly, context can be used, independently of confidence, to determine when to switch the modeling method. For example, if a user has selected to do a squat exercise, we may anticipate that when the head gets too low with respect to the original height, the skeletal tracking may break down. At that point the system may be configured to trigger a transition to an avatar generation model based solely on the location of the center of mass or, alternatively, based on head height only, ignoring whatever results are currently arrived at by the skeleton modeling method. Similarly, when the user head gets high enough again, the skeleton modeling method may once again be employed.

Further, the overall center of mass method itself can be used to check the validity of the skeletal model. To do this, the computing system can effectuate a direct comparison of contact point forces as determined using the skeletal based, and overall center of mass based approaches. When the determinations diverge too much, the computing system may elect to use on the overall center-of-mass based results.

It is understood that any or all of the systems, methods and processes described herein may be embodied in the form of computer executable instructions (i.e., program code) stored on a computer-readable storage medium which instructions, when executed by a machine, such as a computer, server, user equipment (UE), or the like, perform and/or implement the systems, methods and processes described herein. Specifically, any of the steps, operations or functions described above may be implemented in the form of such computer executable instructions. Computer readable storage media include volatile and nonvolatile, removable and non-removable media implemented in any method or technology for storage of information, but such computer readable storage media do not includes signals. Computer readable storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other physical medium which may be used to store the desired information and which may be accessed by a computer.

In describing examples above and as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

We claim:

1. A system comprising:
a processor; and
memory coupled to the processor, the memory comprising executable instructions that, when
executed by the processor cause, the processor to effectuate operations comprising:
determining a first contour of a targeted user from a first image;
determining a first center of mass of the targeted user from the first contour;
determining a first point of contact, at which the targeted user is in contact with a first fixture; and
determining a first force by a constraint analysis comprising a geometrical relationship of the first center of mass to the first point of contact.

2. The system of claim 1, the operations further comprising:
determining a second contour of the targeted user from a second image;
determining a second center of mass of the targeted user from the second contour;
determining a movement from the first center of mass to the second center of mass;
determining an acceleration from the movement and the time difference between the first image and the second image; and
determining the first force, where the constraint analysis further comprises the acceleration.

3. The system of claim 2, the operations further comprising:
during a first period, modeling an avatar by mapping plural identifiable portions of the first contour to skeletal segments of the avatar; and
during a second period, modeling the avatar by inferring the movement of the skeletal segments of the avatar in accordance with the movement.

4. The system of claim 2 the operations further comprising:
determining a second point of contact, at which the targeted user is in contact with a second fixture; and
determining the first force and a second force, where the constraint analysis further comprises a geometrical relationship of the first center of mass to the second point of contact.

5. The system of claim 1, the first fixture comprising at least one of a floor, a wall, a doorway, a bar, a handle, a box, a platform, a bench, or a chair.

6. The system of claim 1, wherein:
the first image comprises a two-dimensional image from a camera; and
the first contour comprises a two dimensional outline.

7. The system of claim 1, the first image comprising a depth image and the first contour comprising a three dimensional depth hull.

8. A method comprising:
determining a first contour of a targeted user from a first image;
determining a first center of mass of the targeted user from the first contour;
determining a first point of contact, at which the targeted user is in contact with a first fixture; and
determining a first force by a constraint analysis comprising a geometrical relationship of the first center of mass to the first point of contact.

9. The method of claim 8, further comprising:
determining a second contour of the targeted user from a second image;
determining a second center of mass of the targeted user from the second contour;
determining a movement from the first center of mass to the second center of mass;
determining an acceleration from the movement and the time difference between the first image and the second image; and
determining the first force, where the constraint analysis further comprises the acceleration.

10. The method of claim 9, further comprising:
during a first period, modeling an avatar by mapping plural identifiable portions of the first contour to skeletal segments of the avatar; and
during a second period, modeling the avatar by inferring the movement of the skeletal segments of the avatar in accordance with the movement.

11. The method of claim 9, further comprising:
determining a second point of contact, at which the targeted user is in contact with a second fixture; and
determining the first force and a second force, where the constraint analysis further comprises a geometrical relationship of the first center of mass to the second point of contact.

12. The method of claim 8, wherein the first fixture comprises at least one of a floor, a wall, a doorway, a bar, a handle, a box, a platform, a bench, or a chair.

13. The method of claim 8, wherein:
the first image comprises a two-dimensional image from a camera; and
the first contour comprises a two dimensional outline.

14. The method of claim 8 wherein:
the first image comprises a depth image; and
the first contour comprises a three dimensional depth hull.

15. A computer-readable storage medium comprising executable instructions that, when executed by a processor, cause the processor to effectuate operations comprising:
determining a first contour of a targeted user from a first image;
determining a first center of mass of the targeted user from the first contour;
determining a first point of contact, at which the targeted user is in contact with a first fixture; and
determining a first force by a constraint analysis comprising a geometrical relationship of the first center of mass to the first point of contact.

16. The computer-readable storage medium of claim 15, the operations further comprising:
determining a second contour of the targeted user from a second image;
determining a second center of mass of the targeted user from the second contour;
determining a movement from the first center of mass to the second center of mass;
determining an acceleration from the movement and the time difference between the first image and the second image; and
determining the first force, where the constraint analysis further comprises the acceleration.

17. The computer-readable storage medium of claim 16, the operations further comprising:
during a first period, modeling an avatar by mapping plural identifiable portions of the first contour to skeletal segments of the avatar; and
during a second period, modeling the avatar by inferring the movement of the skeletal segments of the avatar in accordance with the movement.

18. The computer-readable storage medium of claim 16, the operations further comprising:
determining a second point of contact, at which the targeted user is in contact with a second fixture; and
determining the first force and a second force, where the constraint analysis further comprises a geometrical relationship of the first center of mass to the second point of contact.

19. The computer-readable storage medium of claim 15, wherein:
the first image comprises a two-dimensional image from a camera; and
the first contour comprises a two dimensional outline.

20. The computer-readable storage medium of claim 15, wherein:
the first image comprises a depth image; and
the first contour comprises a three dimensional depth hull.
